(19) United States
(12) Patent Application Publication
(10) Pub. No.: US 2007/0041715 A1
(43) Pub. Date: Feb. 22, 2007

(54) Recording primary and sap audio from a boradcast signal with a dvd recorder

(76) Inventor: Richard Earl Jones, Plainfield, IN (US)

Correspondence Address: THOMSON LICENSING INC., PATENT OPERATIONS, PO BOX 5312, PRINCETON, NJ, 08543-5312, US

(21) Appl. No.: 10/577,262

(22) PCT Filed: Nov. 5, 2004
(86) PCT No.: PCT/US04/37127

§ 371 Date: Apr. 26, 2006

Related U.S. Application Data
(60) Provisional application No. 60/518,545, filed on Nov. 7, 2003.

(51) Int. Cl. H04N 7/00

(52) U.S. Cl. 386/96

(57) ABSTRACT

A method of receiving audio components of a signal and decoding, enabling recording of a first primary audio component and a second SAP, as mono signals based on an input signal and enabling recording of the first primary as a stereo, when only the first primary audio is contained in the signal.

### FIELD OF THE INVENTION

The present invention relates generally to DVD recording, and more particularly to recording primary and SAP audio from an NTSC signal onto recording media.

### BACKGROUND OF THE INVENTION

A secondary audio program signal is broadcast along with a television signal and its primary audio. The second channel, known as a Second Audio Program SAP, is monaural and relatively lo-fi. SAP may be enabled through either a television, a stereo VCR equipped to receive SAP signals, or an SAP receiver. The secondary audio program channel may be used for a variety of enhanced programming, including providing a “video description” of a program's key visual elements, , that describes actions not otherwise reflected in the dialog, used by visually impaired viewers. The descriptive voice-over is inserted in natural pauses in the program so as not to interfere with dialogue, music and sound effects. Many movies and TV programs are described are provided with enhanced descriptions provided through in the secondary audio program channel. Government agencies must caption their videos and multimedia presentations for people who are deaf or hearing impaired, and describe those same presentations for people who are blind or visually impaired. The secondary audio program channel allows broadcasters to provide their programs in a language other than English, and may be used to receiver weather information, or other forms of “real-time” information.

Most standard stereo televisions TVs, video cassette recorders VCRs digital video disk recorders DVD+R are equipped with a feature that enables you to receive secondary audio program SAP content. This is usually a button/switch on the control panel or on the remote control and is most commonly labeled: SAP, MTS, Audio 2, or Audio B. Currently, the consumer must select ahead of time which of the two audio signals will be recorded along with the video recorded by the digital video disk recorder DVD+R. A consumer cannot always know ahead of time whether the secondary audio program content broadcasted along with a video program is desirable to record at the expense of not recording the primary audio content associated with the video program content.

Accordingly, there is a need to allow both the primary audio signal content associated with a video program and secondary audio program content to be recorded so a consumer can then select between the primary and secondary audio content during playback of a recording.

### SUMMARY OF THE INVENTION

A method includes receiving audio components of a signal, enabling recording of a first audio component of the signal as a mono audio component and recording a second audio component of the signal as a second mono audio component, and enabling recording of the first audio component as stereo audio components when only the first audio component is contained in the signal.

A controller in a recording apparatus enables receiving audio components of a signal, enabling recording of a first audio component of the signal as a mono audio component and recording a second audio component of the signal as a second mono audio component, and enabling recording of the first audio component as stereo audio components when only the first audio component is contained in the signal.

A method includes receiving a broadcast signal, recording of a primary audio component of the broadcast signal as a mono audio encoded stream and recording a secondary audio program component of the broadcast signal as a second mono encoded stream when both the primary audio and the secondary audio program components are within the broadcast signal and selected to be recorded, and recording of the primary audio component of the broadcast signal as a stereo encoded stream when only the primary audio component is within the broadcast signal and as a stereo audio signal.

### BRIEF DESCRIPTION OF THE DRAWINGS

A more complete understanding of the present invention may be obtained from consideration of the following description in conjunction with the drawings, in which:

FIG. 1 depicts an exemplary digital video disk recorder configuration for carrying out the inventive recording of both primary audio content and secondary audio program content provided with a broadcast signal, and

FIG. 2 is a flow diagram of a method for carrying out the inventive recording of both primary audio content and secondary audio program content provided with a broadcast signal.

To facilitate understanding, identical reference numerals have been used, where possible, to designate identical elements that are common to the figures.

### DETAILED DESCRIPTION

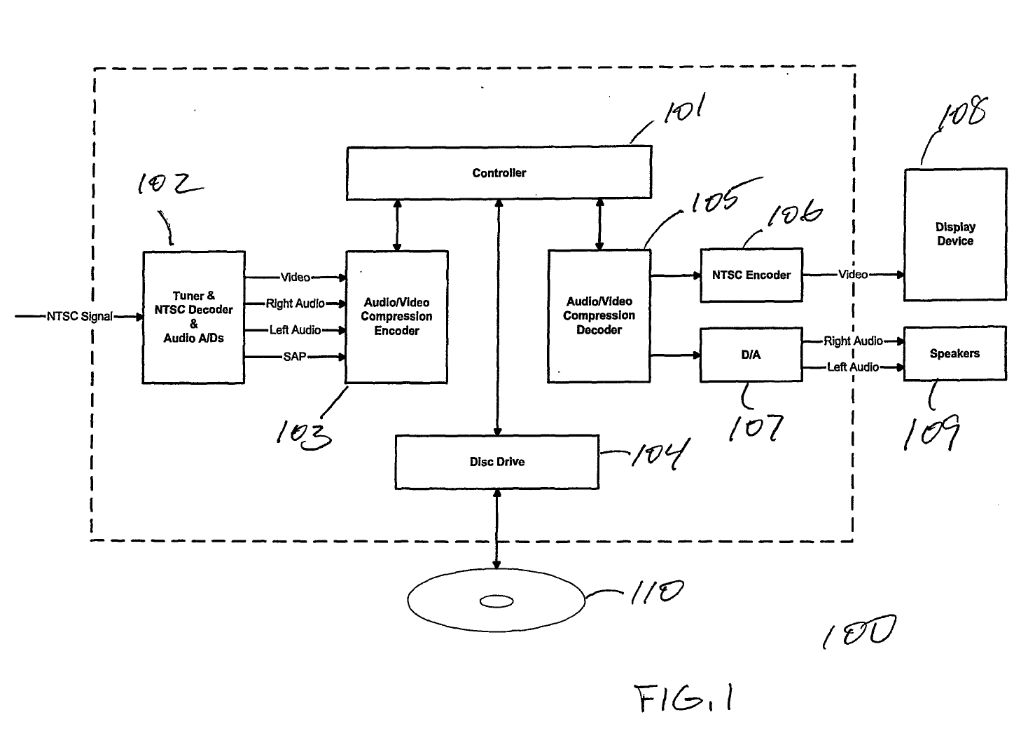

FIG. 1 depicts an exemplary digital video disk recorder configuration 100 for carrying out the inventive recording of both primary audio content and secondary audio program content provided with a broadcast signal. A broadcast signal is received at a tuner block 102 where the video and audio content is decoded and the audio content is digitized to provide video, left and right stereo components of audio associated with the video and the secondary audio program content. The decoded video and digitized stereo audio and secondary audio program components are then compressed and encoded at the audio/video compression encoder block 103. The controller block 101 selectively controls recording of the compressed and encoded video, primary left and right audio components and secondary audio program content by a disk drive 104 onto disk media 110. If the DVD recorder's controller has been set to automatically record secondary audio program content when it is available, the DVD recorder would record the primary audio as a mono encoded stream and the secondary audio program content as a second, separate mono encoded audio stream. In the case that the SAP audio is not broadcast then the DVD recorder's controller 101 would only enable recording the primary audio as either a stereo or mono (if stereo is not broadcast) encoded stream. If a user doesn't set the DVD recorder to record the secondary audio program content then the controller enables only the primary audio to be recorded by the disk drive 104 as either a stereo or mono encoded stream.

During playback mode, enabled by the controller 101, the recorded video and audio is decoded at and audio/video compression decoder block 105, from which the video content is encoded 106 for viewing on a display device 108. Recorded audio from the audio/video decoder block 105 is converted to analog form and played by the speakers. Where both primary stereo audio and secondary audio program content were available and recorded, each audio component is available during playback on the speakers 109 as mono audio content. Where secondary audio program content was not available during recording of the video content, the primary audio content was recorded as stereo left and right components for playback at left and right audio outputs to speakers 109. Where secondary audio program content was not available and primary audio was broadcast as a mono audio signal then that mono audio signal was recorded and available for playback from the disk recorder as a mono audio signal.

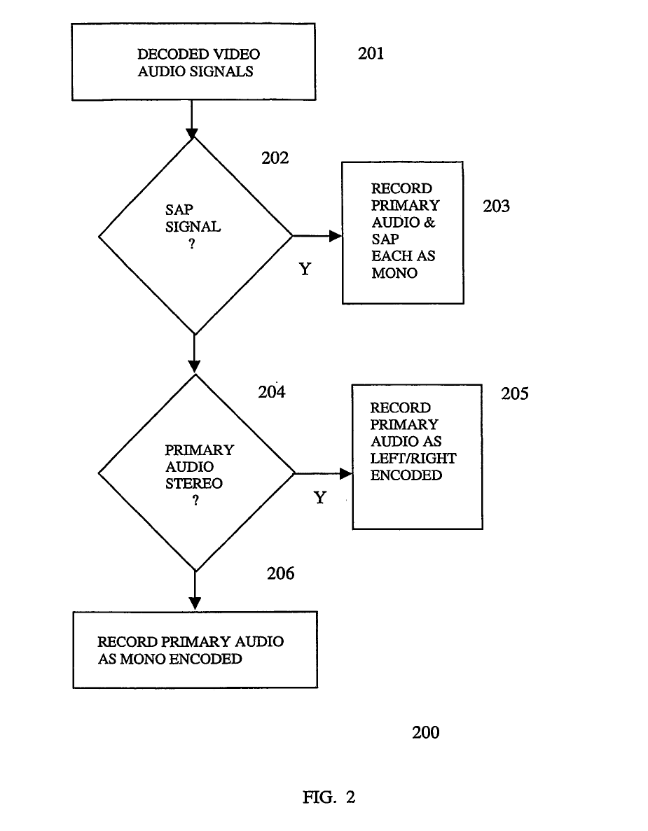

Referring to FIG. 2, there is shown a flow chart 200 of a method for controlled recording of primary audio content and secondary audio program content associated with broadcast video programming. If decoded video and audio signals 201 include secondary audio program content 202 then the disk drive is controlled to record the primary audio and secondary audio SAP each as a mono encoded stream. When the secondary audio program SAP signal was not present for decoding, and the primary audio signal was received and decoded as stereo left and right audio components 204 to the video broadcast, then the primary audio is recorded by the disk drive as encoded left and right audio components 205. When the primary audio was broadcast as a monaural audio component to the video broadcast, then the audio is recorded as a mono encoded stream 206.

Although various embodiments which incorporate the teachings of the present invention have been shown and described in detail in the context of a digital video disk recorder, those skilled in the art can readily devise many other varied embodiments that will still incorporate these teachings.

1. A method comprising the steps of:
receiving audio components of a signal;
enabling recording of a first audio component of said signal as a mono audio component and recording a second audio component of said signal as a second mono audio component; and
enabling recording of said first audio component as stereo audio components when only said first audio component is contained in said signal.

2. The method of claim 1, wherein said first audio component comprises a primary audio component of a video program content.

3. The method of claim 1, wherein said second audio component comprises a secondary audio program content.

4. The method of claim 1, wherein further comprising the step of enabling recording of said first audio component as a mono audio component when only said first audio component is contained in said signal, said first audio component being a mono audio component.

5. The method of claim 1, wherein when each of said first and said second audio components are recorded, they are recorded as encoded mono audio streams.

6. The method of claim 1, wherein when only said first audio component is available from said signal, said first audio component is then recorded as a mono encoded stereo stream.

7. A controller in a recording apparatus for performing the following steps:
receiving audio components of a signal;
enabling recording of a first audio component of said signal as a mono audio component and recording a second audio component of said signal as a second mono audio component; and
enabling recording of said first audio component as stereo audio components when only said first audio component is contained in said signal.

8. The method of claim 7, wherein said first audio component comprises a primary audio component of a video program content.

9. The method of claim 7, wherein said second audio component comprises a secondary audio program content.

10. The method of claim 7, wherein further comprising the step of enabling recording of said first audio component as a mono audio component when only said first audio component is contained in said signal, said first audio component being a mono audio component.

11. The method of claim 7, wherein when each of said first and said second audio components are recorded, they are recorded as encoded mono audio streams.

12. The method of claim 7, wherein when only said first audio component is available from said signal, said first audio component is then recorded as a mono encoded stereo stream.

13. A method comprising the steps of:
receiving a broadcast signal;
recording of a primary audio component of said broadcast signal as a mono audio encoded stream and recording a secondary audio program component of said broadcast signal as a second mono encoded stream when both said primary audio and said secondary audio program components are within said broadcast signal and selected to be recorded; and
recording of said primary audio component of said broadcast signal as a stereo encoded stream when only said primary audio component is within said broadcast signal and as a stereo audio signal.

14. The method according to claim 13, further comprising the step of recording said primary audio component of said broadcast signal as a mono encoded stream when only said primary audio component is within said broadcast signal and as a mono audio signal.
